(19) United States
(12) Patent Application Publication
(10) Pub. No.: US 2017/0031855 A1
(43) Pub. Date: Feb. 2, 2017

(54) MOVABLE STORAGE DEVICE AND METHOD FOR USING THE MOVABLE STORAGE DEVICE IN AN INTELLIGENT TERMINAL

(71) Applicant: TOPDISK ENTERPRISE CO., LTD., Shenzhen (CN)

(72) Inventors: Zhengxian ZHOU, Shenzhen (CN); Lin HU, Shenzhen (CN)

(21) Appl. No.: 15/039,265

(22) PCT Filed: May 21, 2015
(86) PCT No.: PCT/CN2015/079498

§ 371 Date: May 25, 2016

(51) Int. Cl. G06F 13/38; G06F 9/44; G06F 13/40; G06F 3/06; G06F 13/42

(52) U.S. Cl. CPC G06F 13/385; G06F 3/0604; G06F 3/0622; G06F 3/0647; G06F 3/0679; G06F 13/4282; G06F 13/4081; G06F 9/4411; G06F 2213/0042; G06F 2213/3804

(57) ABSTRACT

The present invention provides a movable storage device which comprises an OTG (On-The-Go) controller having an OTG function, a memorizer and/or a memory slot electrically connected to the OTG controller, and a data connector electrically connected to the OTG controller; the movable storage device has a unique identifier, the data connector is a USB Type-C interface. Said movable storage device is provided with a USB Type-C interface, and can be connected to a miniature portable device such as a mobile phone or the like, and transmit data to the minitype portable device. Moreover, the Type-C interface is a high speed miniature standard interface designed according to USB 3.1 specification, the Type-C interface is provided therein with twelve pin terminals arranged in its upper portion and lower portion respectively, said twelve pin terminals are configured for high speed data transmission and providing power supply. The USB Type-C interface can be inserted obversely or reversely, a problem that previous Micro USB interface can only be inserted with its one side, is prone to be inserted inversely and thus be unable to insert, thereby leading to a risk of damaging a USB base of the portable device or a connector of the Micro USB interface has been solved.

### TECHNICAL FIELD

The present application relates to the technical field of data storage, and more particularly, relates to a movable storage device having an OTG (On-The-Go) function and a method for using the movable storage device in an intelligent terminal.

### BACKGROUND

In existing movable storage devices, USB flash disks are the most common. The USB flash disk, with a full name of USB flash disk driver and another English name of USB flash drive, is a miniature mobile storage product with mass memory space which is provided with a USB interface and does not need a physical drive.

USB, with a full name of Universal Serial Bus, is a data transmission bus proposed by a plurality of enterprises including Intel, Compaq, IBM (International Business Machine), Microsoft, etc., and is used for normalizing data connections and communications between computers and external devices.

The development of USB technology enables PCs (Personal Computers) and peripheral devices to connect various devices for data transmission together simply by using a USB bus, so that these devices for data transmission works as peripheries of the PC and perform data exchange under the control of the PC. However, in the convenient method for data exchange, it is impossible for these devices to execute an operation through the USB interfaces in the absence of the PC, because no slave device can function as a Host just like the PC.

OTG is an abbreviation of the word On-To-Go, it is a technique developed based on USB technology, and enables USB devices to be free from limitation of the original master-slave architecture, thereby achieving a terminal to terminal transmission mode.

At present, miniature portable devices such as mobilephones, tablet computers, cameras, and so on, due to limitation of sizes thereof, are difficult to be provided with standard sized USB type-A interfaces similarly to desk computers or notebooks, but are provided with only micro USB interfaces with smaller interface areas. Nowadays, more and more portable devices with the micro USB interfaces are supportive of performing data exchange with conventional USB flash disks using OTG connecting cables, wherein one end of an OTG connecting cable can be connected to a USB type-A interface of a USB flash disk, and the other end of the OTG connecting cable can be connected to a micro USB interface of a device such as a mobilephone or the like, such that data exchange between a micro USB portable device and the USB flash disk is feasible. However, in case of the absence of the OTG connecting cables, data exchange between the conventional USB flash disk and the device such as the mobilephone or the like is infeasible; it is inconvenient for a user to bring an OTG connecting cable, and thus much inconvenience will be brought to the user.

In the prior art, the USB flash disk and the portable device are connected together by the OTG connecting cable, thus management of files in the USB flash disk can only rely on a complicated user interface of the portable device and lots of folders. It is quite inconvenient to use and even very hard for common users, only professionals can perform the method skillfully.

### CONTENTS OF THE INVENTION

The present invention aims at providing a movable storage device having an OTG function and a method for using the same, with the purpose of solving a problem in the prior art that that a USB flash disk is connected with a portable device by an OTG connecting cable, and files in the USB flash disk can only be managed by a complicated user interface of the portable device and lots of folders, thereby making the use of the movable storage device be quite inconvenient.

The present invention provides a movable storage device, which comprises an OTG controller having an OTG function, a memorizer and/or a memory slot electrically connected to the OTG controller, and a data connector electrically connected to the OTG controller; the movable storage device has a unique identifier, the data connector is a USB Type-C interface.

The aforesaid movable storage device is provided with a Type-C interface, and can be connected with a miniature portable device such as a mobile phone through the Type-C interface for data transmission. Moreover, the Type-C interface is a high speed miniature standard interface designed according to USB 3.1 specification, and is provided therein with twelve pin terminals arranged in an upper layer and a lower layer thereof respectively, the twelve pin terminals are configured for high speed data transmission and providing power supply. The Type-C interface can be inserted obversely or reversely, and a problem that a previous Micro USB interface can only be inserted with its one side, is prone to be inserted inversely and thus be unable to insert, thereby leading to a risk of damaging a USB base of the portable device or a connector of the Micro USB interface has been solved.

The present invention further provides a method for using the aforesaid movable storage device in an intelligent terminal, comprising the following steps:

when a movable storage device is accessed, detecting whether the movable storage device has a unique identifier or not;

if yes, scanning and classifying data stored in the movable storage device, and generating a plurality of classified groups;

generating a plurality of folders matching with the classified groups, and then mapping and linking the classified groups with the folders corresponding to the classified groups.

When said method of using the movable storage device in the intelligent terminal is equipped with application software, it can retransfer and back-up information including data, pictures, photos, videos in the portable device very conveniently; it can also directly read data information stored in a memory disk having a USB Type-C OTG function of the present invention from the portable device, and thus great convenience and practicability can be obtained.

It is mainly reflected that the movable storage device is equipped with a graphical application software environment. This OTG storage device with a perfect combination of software and hardware achieves an interactive management mode. A user can experience infinite technological enjoyment brought by the OTG movable storage device having the USB Type-C interface, such that a unique application new environment can be added to a formalistic product, which has already surpassed the concept of the original storage devices. On the basis of the practicability, more convenience is added. At this age when almost everyone uses portable devices, charm of the OTG external storage is highlighted, further in view of convenient and practical application software, the OTG external storage is actually even better.

A graphical and humanistic management is performed using application software, so that sharing and mutual file transmission of various documents between an internal storage area and an external storage area can be achieved by the user. Sharing mode without any obstacles can be performed between pictures, musics, videos and various documents in the portable device and the external storage area.

Charm of the APP software is that the APP software makes man and machine be combined as one, each application is decomposed by hierarchical icons, lots of complicated and repeated procedures are reduced, and an interactive experience can be brought to the user.

### BRIEF DESCRIPTION OF THE DRAWINGS

FIG. 1 illustrates a disassembled view of a movable storage device of a preferred embodiment of the present invention;

FIG. 2 illustrates a stereoscopic structural schematic diagram of a USB Type-C interface used in the movable storage device of the embodiment of the present invention shown in FIG. 1;

FIG. 3 illustrates a front schematic view of connecting pins of the USB Type-C interface shown in FIG. 2;

FIG. 4 illustrates an assembled view of the movable storage device in the preferred embodiment of the present invention, wherein the USB Type-C interface is in a received status;

FIG. 5 illustrates an assembled view of the movable storage device in the preferred embodiment of the present invention, wherein the USB Type-C interface is in an exposed status;

FIG. 6 illustrates a flow chart of a method for using the movable storage device shown in FIG. 5 in an intelligent terminal;

FIG. 7 illustrates an application software architectural schematic diagram of the method for using the movable storage device in the intelligent terminal of the preferred embodiment of the present invention.

### DETAILED DESCRIPTION OF THE PREFERRED EMBODIMENT

In order to make the technical problems to be solved by the present invention, the technical solution and the advantages of the present application be more clear and understandable, the present application will be described in detail with reference to the accompanying drawings and embodiments. It should be understood that the specific embodiments described herein are used for interpretation of present invention merely, rather than the limitation to the present invention.

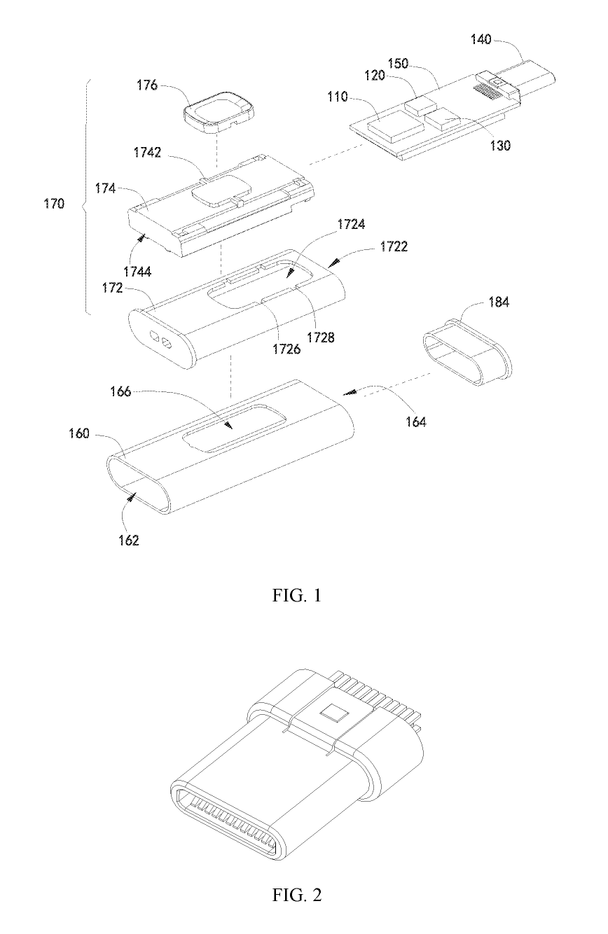

Please refer to FIG. 1, a movable storage device of a preferable embodiment of the present invention comprises a OTG (On-To-Go) controller 110, a memorizer 120 and/or a memory slot 130, a data connector 140, a circuit board 150 (PCB, Printed Circuit Board). Wherein, the OTG controller 110 is electrically connected to the memorizer 120 and/or the memory slot 130, the data connector 140 is electrically connected to the OTG controller 110. Moreover, the movable storage device has a unique identifier, the data connector 140 is a USB (Universal Serial Bus) Type-C interface. Specifically, the movable storage device can be provided therein with the memorizer 120 or the memory slot 130, or be provided therein with both the memorizer 120 and the memory slot 130. The memory slot 130 is a SD (Secure Digital) card socket or a Micro SD card socket.

Specifically, the OTG controller 110, the data connector 140, the memorizer 120 and/or the memory slot 130 are electrically connected to the circuit board 150 respectively, the OTG controller 110 and the memorizer 120 and/or the memory slot 130 are arranged on the circuit board 150, the data connector 140 is fixed to one end of the circuit board 150. In this way, the OTG controller 110, the memorizer 120 and/or the memory slot 130, the data connector 140 and the circuit board 150 are electrically connected together to form a movable storage device. When the USB Type-C interface is connected with a portable device which supports an OTG function and also has a USB Type-C interface, functions including sharing of files, pictures and video media in the memorizer 120 and transmission and storing of data in the memorizer 120 can be realized.

Specifically, the OTG controller 110 is a controller chip with the USB OTG function, and can take control of accessing to the memorizer 120 requested by other possible components. The unique identifier can be a serial number, or a vendor ID (Identity Card), or a product ID.

The memorizer 120 is configured for storing data, such as text files, pictures, video media, procedure codes, and so on. The memorizer 120 can comprise a high speed RAM (Random Access Memory) 120, and can also comprise a NVM (Nonvolatile Memory) 120, such as one or a plurality of magnetic storage device(s), flash memory (memories), or other nonvolatile solid-state memory/memories 120. Wherein, the flash memory can be a storage card, and can also comprise a SD card (Secure digital memory card) with a card socket, or an internal storage or external storage used by a TF (TransFlash, or called Micro SD) card. Meanwhile, the flash memory can further make a general reference to any miniature storage chip having an EMMC (Embedded Multi Media Card) function, and the specific implementation of the present invention should not be limited by the flash memory.

An interface of the data connector 140 is a USB Type-C interface which completely meets a USB Type-C specification. The USB Type-C interface specification is included in a USB 3.1 specification, the USB 3.1 data transmission rate can be raised up to 10 Gbps (Giga Byte Per Second). The USB Type-C specification interface has four features as follows: first, the USB Type-C interface has a smaller size which is similar to existing USB 2.0 micro-B; second, the USB Type-C interface is in support of a power supply charging capability; third, the USB Type-C interface has a high expansibility, and the design of the USB Type-C interface shall be in support of capability of USB 4.0 in the future; fourth, usability: the USB Type-C interface can be inserted obversely and reversely, it is unnecessary for a user to identify an obverse and a reverse of the USB Type-C interface, and it is easier for the USB Type-C interface to be inserted.

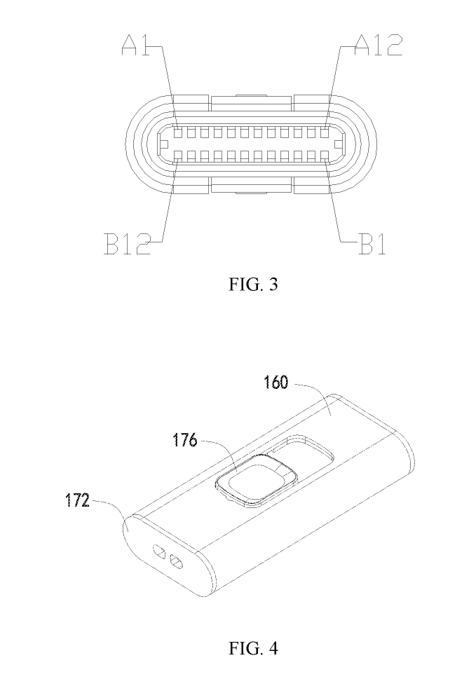

Please refer to FIG. 2 and FIG. 3, generally speaking, the USB Type-C interface has at least 24 connecting pins, FIG. 3 shows connecting pins arranged in an upper layer and in an lower layer respectively, wherein twelve connecting pins arranged from left to right in the upper layer are marked respectively by identification markers from A1 to A12 (in FIG. 3, only the first connecting pin and the twelfth connecting pin arranged in the upper layer are marked), another twelve connecting pins arranged from left to right in the lower layer are marked respectively by identification markers from B1 to B12 (in FIG. 3, only the first connecting pin and the twelfth connecting pin arranged in the lower layer are marked). Wherein, the USB Type-C interface comprises at least four power supply pins (i.e., the fourth connecting pin and the ninth connecting pin arranged in the upper layer and the fourth connecting pin and the ninth connecting pin arranged in the lower layer), four ground pins (i.e., the first connecting pin and the twelfth connecting pin arranged in the upper layer and the first connecting pin and the twelfth connecting pin arranged in the lower layer), four differential signal pins (the second connecting pin, the third connecting pin, the sixth connecting pin, the seventh connecting pin, the tenth connecting pin, and the eleventh connecting pin arranged in the upper layer, and the second connecting pin, the third connecting pin, the sixth connecting pin, the seventh connecting pin, the tenth connecting pin, and the eleventh connecting pin arranged in the lower layer), two selection pins (the fifth pin arranged in the upper layer and the fifth pin arranged in the lower layer), and two remaining pins (the eighth pin arranged in the upper layer and the eighth pin arranged in the lower layer).

From FIG. 3 it can be seen that the definition order of the pins arranged in the upper layer of the USB Type-C interface is exactly opposite to the definition order of the pins arranged in the lower layer of the USB Type-C interface, therefore, whether the USB Type-C interface is inserted obversely or reversely, data connection is identical, and high speed data transmission can be performed between the USB Type-C interface and a mobile terminal device supporting the OTG function and also having a USB Type-C interface; moreover, the USB Type-C interface has a smaller size, and thus possesses great convenience and practicability, this is the most remarkable feature of the movable storage device of the present invention.

Please go on referring to FIG. 1, further, in order to be convenient for the user to use and carry the movable storage device, and also in order to protect internal components of the movable storage device, the movable storage device further comprises an outer shell 160, the outer shell 160 encases the circuit board 150, the OTG controller 110, the data connector 140, the memorizer 120 and/or the memory slot 130, an interface of the data connector 140 is exposed to the outside of the outer shell 160.

In a further embodiment, the movable storage device further comprises a sliding component 170, the circuit board 150 is fixed to the sliding component 170, the sliding component 170 is arranged in the outer shell 160, two opposite ends of the outer shell 160 are provided with a first openings 162 and a second openings 163 respectively, the sliding component 170 blocks the first openings 162, and is configured for receiving the interface of the data connector 140 in the outer shell 160 or exposing the interface of the data connector 140 to the outside of the second openings 163.

Specifically, the sliding component 170 comprises a fixing glue piece 172, a sliding glue piece 174 and a push button 176, the circuit board 150 is fixed to the sliding glue piece 174, the fixing glue piece 172 is provided with a cavity 1722, the sliding glue piece 174 is slidingly received in the cavity 1722, the fixing glue piece 172 is fixed in the outer shell 160 and blocks the first openings 162; the outer shell 160 is provided with an open window 166 arranged on a lateral thereof, the fixing glue piece 172 is provided with an open hole 1724 arranged on a position of its lateral wall facing the open window 166 of the outer shell 160, the sliding glue piece 174 is provided thereon with a bulge structure 1742 exposed in the open hole 1724, the push button 176 is fixedly connected with the sliding glue piece 174, the push button 176 is movable within the scope of the open hole 1724. The open window 166 or the open hole 1724 is provided with at least one first bayonet 1726 and at least one second bayonet 1728 at an edge thereof, the push button 176 is pressed and pushed to make the bulge structure snap into the first bayonet 1726 or the second bayonet 1728, such that the interface of the data connector 140 can be received in the outer shell 160 or be exposed to the outside of the second openings 163. Please refer to FIG. 1, in this embodiment, the first bayonet 1726 and the second bayonet 1728 are respectively arranged on an edge of the open hole 1724 of the fixing glue piece 172, and there are two mutually symmetrical first bayonets 1726 and two mutually symmetrical second bayonets 1728. In another embodiment, the first bayonet 1726 and the second bayonet 1728 can be arranged on the open window 166 of the outer shell 160.

In the embodiment of the present invention, the sliding glue piece 174 is cylinder-shaped and has at least one opening, the bulge structure 1742 is formed on an outer wall of the sliding glue piece 174, the circuit board 150 is encased by the sliding glue piece 174 and received in a cavity body 1744, the interface of the data connector 140 is exposed to the sliding glue piece 174.

Furthermore, the movable storage device further comprises a cover cap 184, the cover cap 184 is sheathed on the second openings 163 such that the interface of the data connector 140 is encased in the cover cap 184. In this way, under the circumstance of absence of the sliding glue piece 170, the cover cap 184 can also provide protection for the interface of the data connector 140 exposed outside. Moreover, even under the circumstance of use of the sliding glue piece 170, the cover cap 184 can also provide further protection for the internal components.

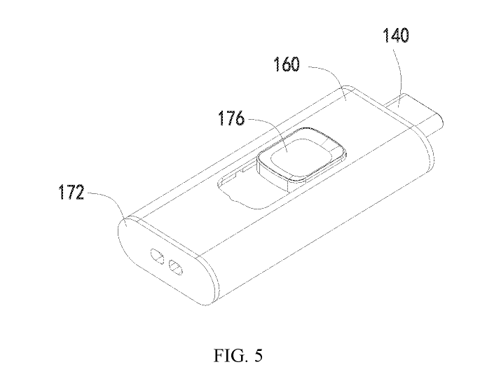

Please refer to FIG. 4, when the push button 176 is pushed to a bottom edge, the bulge structure 1742 of the sliding glue piece 174 snaps into the first bayonet 1726, the USB Type-C interface is retracted, and thus the movable storage device can be stored conveniently without using the cover cap 184. Please refer to FIG. 5, when the push button 176 is pushed to a top edge, the bulge structure 1742 of the sliding glue piece 174 snaps into the second bayonet 1728, the USB Type-C interface is protruded and in an exposed status, which can be used for connecting to a portable device to use at this moment, under the circumstance that the interface is not changed into the status of FIG. 4, the cover cap 184 can be used for protecting the USB Type-C interface.

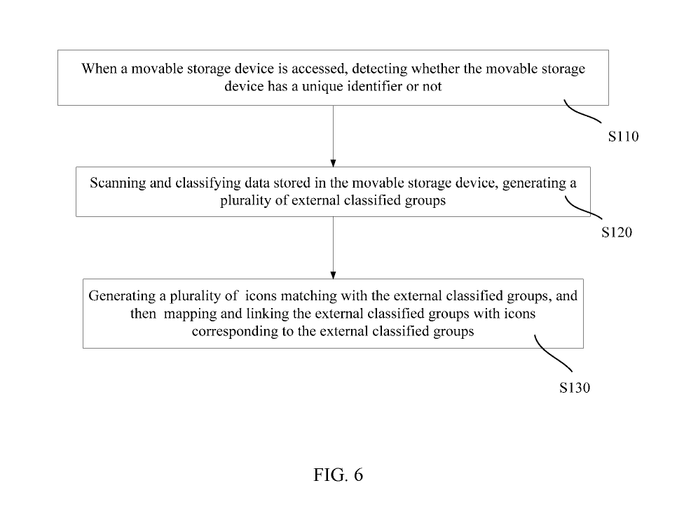

In addition, please refer to FIG. 6, a method for using the aforesaid movable storage device in an intelligent terminal is further provided, and the method comprises steps in the following:

Step 110, when a movable storage device is accessed, detecting whether the movable storage device has a unique identifier or not.

Specifically, only when the detected unique identifier is correct, the APP (Application) software operating on the intelligent terminal can be activated; otherwise, the APP software can't be activated. For example, only when a serial number of an inserted OTG movable storage device is included in a pre-designed serial number list, said serial number can be identified, and the APP software of the intelligent terminal can be used.

Step 120, scanning and classifying data stored in the movable storage device, and generating a plurality of external classified groups.

Furthermore, the method further comprises a step of scanning and classifying data stored in an internal storage device of the intelligent terminal, and generating a plurality of internal classified groups. That is, searching in the internal storage device and the external storage device, and performing unified management for corresponding documents, which includes a group comprising pictures, musics, videos, files, E-books, address books, or the like.

Step 130, generating icons matching with the plurality of external classified groups, and then mapping and linking the external classified groups with the icons corresponding to the external classified groups.

Furthermore, the method further comprises a step of generating a plurality of icons matching with the internal classified groups, and then mapping and linking the internal classified groups with the icons corresponding to the internal classified groups.

Even further, the method further comprises the following steps:

generating a first back-up icon; when an external instruction is received, generating a folder matching with the internal classified groups in the movable storage device, and synchronizing the internal classified groups in the internal storage device into a corresponding folder for back-up or replying;

generating a second back-up icon; when an external instruction is received, generating a folder matching with the external classified groups in the internal storage device, and synchronizing the external classified groups in the external storage device into corresponding folder for back-up or replying.

In this way, unified management for data in the internal storage device and the external storage device can be performed using the aforesaid generated icons.

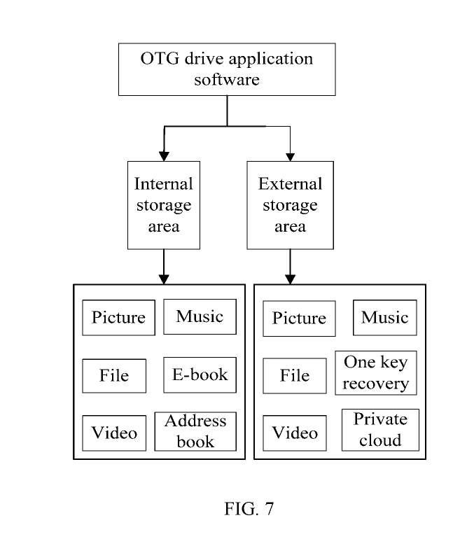

As shown in FIG. 7, in a holistic architecture of the APP software (the aforesaid application method), a very intuitional icon hierarchical user interface is used. A first hierarchy is an icon of “OTG Drive APP”, after it is clicked, a second hierarchy is entered, wherein the second hierarchy includes two modules, that is, an internal storage area and an external storage area. The internal storage area directly manages some documents stored in the portable device itself, this is a third hierarchy which includes modules of pictures, musics, videos, documents, E-books, address books, or the like. Various documents are managed graphically and human-friendly using APP software, which is convenient and practical, and user experience can be improved. The external storage area is the one which corresponds to the internal storage area and lies in the third hierarchy too. The external storage area refers to an added storage area configured to connect the portable device to external, and a USB Type-C OTG storage device is one example of the external storage area. The external storage area is managed graphically and human-friendly using APP software too, when the internal storage space is not enough or the internal storage space cannot be used, pictures, musics, videos, and other application documents coming from the external can also be shared by the user. Of course, various sharing functions such as mutually sharing and mutual file transmission between the internal storage area and the external storage area can be totally supported, such that a sharing mode without any obstacles can be performed between pictures, musics, videos and various documents in the portable device and pictures, musics, videos, and various documents in the external storage area.

Charm of the APP software is that the APP software makes man and machine be combined as one, each application is decomposed by hierarchical icons, lots of complicated and repeated procedures are reduced, and an interactive experience can be brought to the user.

In contrast with an existing mobile device file manager, advantages of our APP software lies in:

1. a visual graphic operation interface is provided. A corresponding document can be found by directly clicking an APP icon, documents are sorted automatically and managed according to preset categories, and copying, transmission and broadcast for the documents can be realized between the internal storage device and the external storage device. However, when a file manager of existing mobile device is opened, various documents are complicated, and it is really difficult for the user to find out a required documents.

2. The operation is more convenient and simple, and both time and effort are saved. Category of APP software is clear, and the icons are concise. Document(s) needed by the user can be found very conveniently and quickly by clicking icon(s) corresponding to the document(s). However, the file manager of the existing mobile device needs to open many folders to find corresponding document(s).

3. a specialized APP has much more value-added function software, such as the functions of one key recovery, back-up of address book, E-book, private cloud, or the like.

The aforementioned embodiments are only preferred embodiments of the present invention, and should not be regarded as being any limitation to the present invention. Any modification, equivalent replacement, improvement, and so on, which are made within the spirit and the principle of the present invention, should be included within the protection scope of the present invention.

1. A movable storage device, comprising an OTG controller having an OTG function, a memorizer and/or a memory slot electrically connected to the OTG controller, and a data connector electrically connected to the OTG controller; wherein the movable storage device has a unique identifier, and the data connector is a USB Type-C interface.

2. The movable storage device according to claim 1, further comprising a circuit board, wherein the OTG controller, the data connector, the memorizer and/or the memory slot are electrically connected to the circuit board respectively, the OTG controller and the memorizer and/or the memory slot are arranged on the circuit board, the data connector are fixed to one end of the circuit board.

3. The movable storage device according to claim 2, further comprising an outer shell, wherein the outer shell encases the circuit board, the OTG controller, the data connector, the memorizer and/or the memory slot, and an interface of the data connector is exposed to an outside of the outer shell.

4. The movable storage device according to claim 2, further comprising a sliding component, wherein the circuit board is fixed to the sliding component, the sliding component is arranged in the outer shell, two opposite ends of the outer shell are provided with a first opening and a second opening respectively, the sliding component blocks the first openings, the sliding component is configured for receiving the interface of the data connector in the outer shell or exposing the interface of the data connector to the outside of the second opening.

5. The movable storage device according to claim 4, wherein, the sliding component comprises a fixing glue piece, a sliding glue piece, and a push button; the circuit board is fixed to the sliding glue piece, the fixing glue piece is provided with a cavity, the sliding glue piece is slidingly received in the cavity, the fixing glue piece is fixed in the outer shell and blocks the first openings;
the outer shell is provided with an open window arranged on a lateral wall thereof, a lateral wall of the fixing glue piece is provided with an open hole arranged at a position facing the open window of the outer shell, the sliding glue piece is provided thereon with a bulge structure exposed in the open holehole, the push button and the sliding glue piece are in fixed connection and can be movable within the scope of the open holehole, the open window or the open holehole is provided with a first bayonet and a second bayonet at an edge thereof, when the push button is pressed and pushed, the bulge structure is snapped into the first bayonet or the second bayonet, such that the interface of the data connector can be received in the outer shell or exposed to the outside of the second openings.

6. The movable storage device according to claim 5, wherein the sliding glue piece is cylinder-shaped and has at least one opening, the bulge structure is formed on an outer wall of the sliding glue piece, the circuit board is encased in the sliding glue piece, the interface of the data connector is exposed to the sliding glue piece.

7. The movable storage device according to claim 3, further comprising a cover cap, wherein the cover cap is sheathed on the second opening such that the interface of the data connector is encased in the cover cap.

8. A method for using the movable storage device in an intelligent terminal, comprising the following steps:
when the movable storage device is accessed, detecting whether the movable storage device has a unique identifier or not;
if yes, scanning and classifying data stored in the movable storage device, and generating a plurality of external classified groups;
generating a plurality of icons matching with the external classified groups, and then mapping and linking the external classified groups with the icons corresponding to the external classified groups.

9. The method according to claim 8, further comprising:
scanning and classifying data stored in an internal storage device of the intelligent terminal, and generating a plurality of internal classified groups;
generating a plurality of icons matching with the plurality of internal classified groups, and then mapping and linking the internal classified groups with the icons corresponding to the internal classified groups.

10. The method according to claim 8, wherein, the unique identifier is a serial number, or a Vendor ID, or a Product ID.

11. The movable storage device according to claim 4, further comprising a cover cap, wherein the cover cap is sheathed on the second opening such that the interface of the data connector is encased in the cover cap.
